(19) United States
(12) Patent Application Publication
(10) Pub. No.: US 2025/0339329 A1
(43) Pub. Date: Nov. 6, 2025

(54) MEDICAL HAND AND FOREARM FIXING DEVICE

(71) Applicant: MEDISBY CO., LTD., Seoul (KR)

(72) Inventors: Joonryul LIM, Seoul (KR); Yong Min Chun, Seoul (KR)

(73) Assignee: MEDISBY CO., LTD., Seoul (KR)

(21) Appl. No.: 19/265,321

(22) Filed: Jul. 10, 2025

Related U.S. Application Data
(63) Continuation of application No. PCT/KR2024/000546, filed on Jan. 11, 2024.

(30) Foreign Application Priority Data
Jan. 11, 2023 (KR) 10-2023-0003816

(51) Int. Cl. A61H 1/02

(52) U.S. Cl. CPC A61H 1/0281; A61H 1/0277; A61H 2201/1635; A61H 2201/1659

(57) ABSTRACT

Disclosed is a medical hand and forearm fixing device including a fixing part, to which a forearm of a user is fixed, and a handle that is provided on one surface of the fixing part to be tilted, and is gripped by a hand of the user. The handle is tilted at a specific angle corresponding to an anatomical structure of a hand or a wrist of the user, relative to the perpendicular direction of the one surface of the fixing part.

### CROSS-REFERENCE TO RELATED APPLICATIONS

The present application is a continuation of International Patent Application No. PCT/KR2024/000546, filed on Jan. 11, 2024, which is based upon and claims the benefit of priority to Korean Patent Application No. 10-2023-0003816 filed on Jan. 11, 2023. The disclosures of the above-listed applications are hereby incorporated by reference herein in their entirety.

### BACKGROUND

Embodiments of the present disclosure described herein relate to a medical hand and forearm fixing device.

Due to shoulder joint diseases, instability is accompanied by shoulder dislocation in young adults, and impingement syndrome, frozen shoulder, and rotator cuff tear are accompanied in middle-aged individuals, and the number of patients requiring shoulder joint replacement surgery is increasing in elderly individuals. After such surgeries, the most important aspect for patients is to recover and maintain the joint motion range after the surgery. In addition, the shoulder may develop a condition called frozen shoulder, which reduces the shoulder joint motion range and causes pain, with an incidence rate of about 1% in the population, and in this case, the joint motion range is recovered by a treatment.

Furthermore, when a specific portion of the brain is damaged due to stroke, cerebral infarction, or traumatic brain injury, motor paralysis of one or both upper limbs may occur, and in the case of upper limbs that have a wide joint motion range, treatment for continuously maintaining the joint motion range is very important.

However, the number of medical professionals who are responsible for treatment to recover and maintain the joint motion range is still insufficient compared to the number of patients, and due to the physical limitations of the medical staff, it is difficult for patients to receive sufficient and satisfactory joint motion therapy.

For this reason, treatment robots, such as manual therapy robots, have recently been introduced to assist the efforts and procedures of therapists.

An upper limb joint motion therapy robot not only may induce sufficient, consistent, and intensive training for the patient, but also may standardize the training through processes, such as repetitive training, adjustment of training amount and duration, and quantification of training progress and outcomes, thereby reducing the physical burden on the therapist.

The upper limb joint motion therapy robot includes a robot arm and a forearm fixing device that is coupled to the robot arm and, in which a forearm of a patient is fixed, and may perform treatment to recover and maintain the motion range of the upper limb joints of the patient by moving the forearm fixing device, in which the forearm of the patient is fixed by using the robot arm. According to the structure of such a forearm fixing device, a movable range of the robot arm and a force required for the movement of the robot arm may vary, and this directly affects the treatment effect of recovering and maintaining the range of motion of the upper limb joints of the patient.

Meanwhile, in a normal wrist, when a fist is made in a neutral position, the little finger is positioned closer to a proximal portion (a wrist side) than the index finger. This is because the wrist has a radial tilt.

However, a conventional forearm fixing device has a problem in that the radial tilt of the wrist is not reflected in the handle that is gripped by the hand of the patient, thereby increasing the wrist fatigue of the patient who grips the handle.

In addition, in a conventional forearm fixing device, because the fixed portion with the robot arm is limited to a specific point, there is a lack of versatility.

### SUMMARY

Embodiments of the present disclosure provide a medical hand and forearm fixing device that may reduce fatigue of a wrist of a user that grips a handle and has versatility.

Problems to be solved by the present disclosure are not limited to the problems mentioned above, and other problems that are not mentioned will be clearly understood by those skilled in the art from the following description.

According to an embodiment, a medical hand and forearm fixing device may include a fixing part, to which a forearm of a user is fixed, and a handle that is provided on one surface of the fixing part to be tilted, and is gripped by a hand of the user, and the handle may be tilted at a specific angle corresponding to an anatomical structure of a hand or a wrist of the user, relative to the perpendicular direction of the one surface of the fixing part.

Furthermore, the handle may be tilted at a specific angle corresponding to a radial tilt of the wrist of the user with respect to the perpendicular direction that is perpendicular to the one surface of the fixing part.

The radial tilt angle with respect to a forearm of a typical radius may be 22° to 24°, and because a functional radial tilt angle decreases when a fist is made, a specific angle that reflects the radial tilt angle of the forearm fixing apparatus that reflects this may be 10° to 12°.

Furthermore, the fixing part may include a proximal section, in which a proximal portion of the forearm is held, a distal section, in which a distal portion of the forearm is held, and a central section, in which a portion between the proximal portion of the forearm and the distal portion of the forearm is held, and the handle may be provided in the proximal section.

Furthermore, the medical hand and forearm fixing device may further include a plurality of frames that are provided on an opposite surface of the fixing part at intervals, and a connector that is coupled to any one of the plurality of frames to be separable, and is provided in a robot arm, and the plurality of frames include a proximal frame that is provided in the proximal section, a central frame that is provided in the central section, and a distal frame that is provided in the distal section.

Furthermore, the medical hand and forearm fixing device may further include a controller that controls the robot arm, and the controller may control the robot arm such that a shoulder joint motion of the user is performed when the connector is coupled to the proximal frame, may control the robot arm such that the shoulder joint motion of the user or an elbow joint motion of the user is performed when the connector is coupled to the central frame, and may control the robot arm such that at least one of the shoulder joint motion of the user or the elbow joint motion of the user is performed when the connector is coupled to the distal frame.

Furthermore, an insertion recess, into which the frame is inserted, may be formed in the connector.

Furthermore, a through-hole may be formed in the frame, a pair of communication holes for fluid-communication may be formed in the connector on opposite sides of the insertion recess, the pair of communication holes may communicate with opposite sides of the through-hole while the frame is inserted into the insertion recess, and the medical hand and forearm fixing device may further include a locking part that is inserted into the pair of communication holes and the through-hole, and that locks the frame and the connector while the frame is inserted into the insertion recess.

Furthermore, the locking part may include a locking body that is inserted into the communication holes and the through-hole while the frame is inserted into the insertion recess, and a locking guide that is provided at one end of the locking body, and has a shape, a cross-sectional area of which decreases in a direction becoming more distant from the locking body.

Furthermore, the locking part may further include a locking step that is provided at an opposite end of the locking body, and is stopped by the frame when the locking body is inserted into the pair of communication holes and the through-hole.

Furthermore, a hollow hole may be formed in the locking step.

The other details of the present disclosure are included in the detailed description and the drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a schematic view illustrating a state, in which a central frame of a medical hand and forearm fixing device and a robot arm are coupled to each other, according to an embodiment of the present disclosure;

FIG. 2 is an exploded perspective view illustrating a medical hand and forearm fixing device according to an embodiment of the present disclosure;

FIG. 3A is a perspective view illustrating a state, in which a user's hand grips a handle of a medical hand and forearm fixing device according to an embodiment of the present disclosure;

FIG. 3B is a perspective view illustrating a state, in which a user's hand is separated from a handle of a medical hand and forearm fixing device according to an embodiment of the present disclosure;

FIG. 4 is a schematic view illustrating a state, in which a proximal frame of a medical hand and forearm fixing device and a robot arm are coupled to each other, according to an embodiment of the present disclosure; and

FIG. 5 is a schematic view illustrating a state, in which a distal frame of a medical hand and forearm fixing device and a robot arm are coupled to each other, according to an embodiment of the present disclosure.

### DETAILED DESCRIPTION

The above and other aspects, features and advantages of the present disclosure will become apparent from embodiments to be described in detail in conjunction with the accompanying drawings. The present disclosure, however, may be embodied in various different forms, and should not be construed as being limited only to the illustrated embodiments. Rather, these embodiments are provided as examples so that the present disclosure will be thorough and complete, and will fully convey the scope of the present disclosure to those skilled in the art. The present disclosure may be defined by the scope of the claims.

The terms used herein are provided to describe embodiments, not intended to limit the present disclosure. In the specification, the singular forms include plural forms unless particularly mentioned. The terms “comprises” and/or “comprising” used herein do not exclude the presence or addition of one or more other components, in addition to the aforementioned components. The same reference numerals denote the same components throughout the specification, and the term “and/or” includes each of the mentioned components and all combinations of one or more of the components. It will be understood that, although the terms “first”, “second”, etc., may be used herein to describe various components, these components should not be limited by these terms. These terms are only used to distinguish one component from another component. Thus, a first component that is discussed below could be termed a second component without departing from the technical idea of the present disclosure.

Unless otherwise defined, all terms (including technical and scientific terms) used herein have the same meaning as commonly understood by those skilled in the art to which the present disclosure pertains. The terms, such as those defined in commonly used dictionaries, should not be interpreted in an idealized or overly formal sense unless expressly so defined herein.

As illustrated in the figures, spatially relative terms, such as “below”, “beneath”, “lower”, “above”, “upper”, and the like, may be used herein for ease of description to describe the relationship between one component and other components. It will be understood that the spatially relative terms are intended to encompass different orientations of the components in use or operation in addition to the orientation depicted in the figures. For example, when inverting a component shown in the figures, a component described as “below” or “beneath” of another component may be placed “above” another element. Thus, the exemplary term “below” may include both downward and upward directions. The components may also be oriented in different directions, and thus the spatially relative terms may be interpreted depending on orientation.

Hereinafter, embodiments of the present disclosure will be described in detail with reference to accompanying drawings.

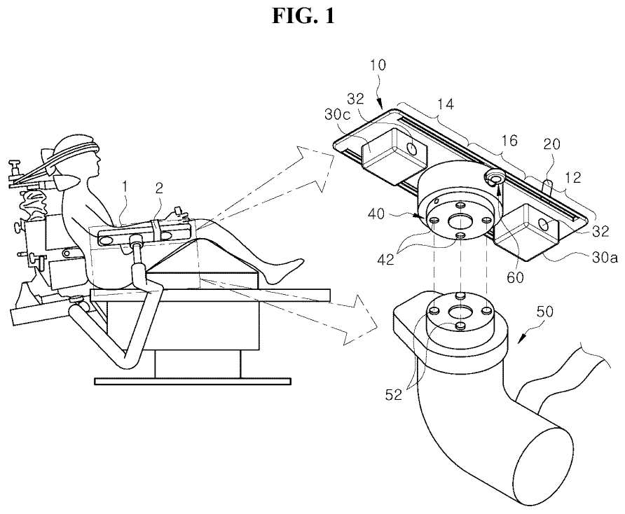

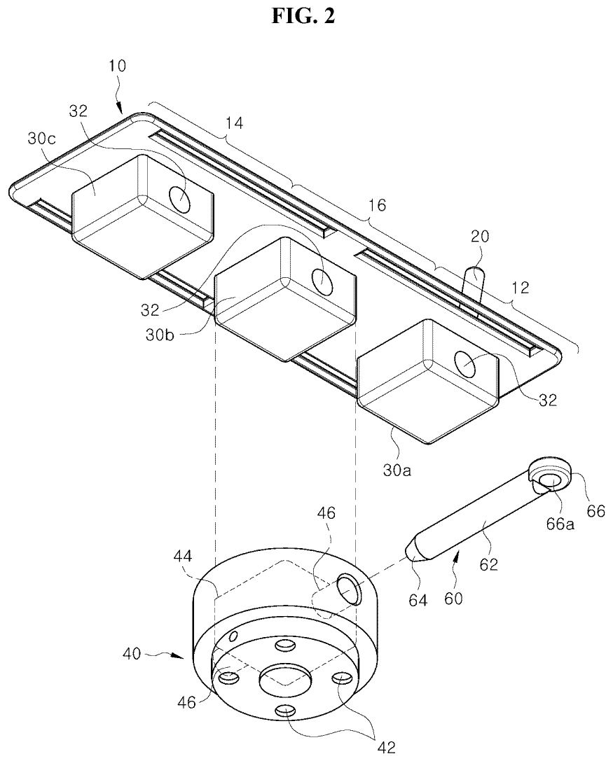

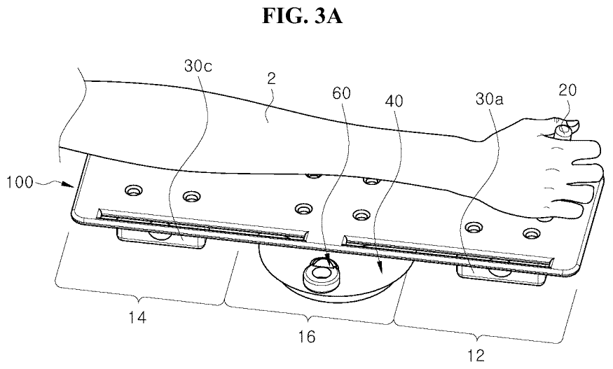

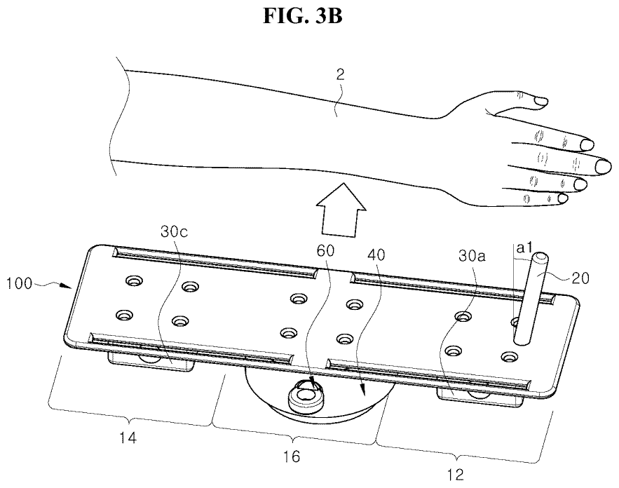

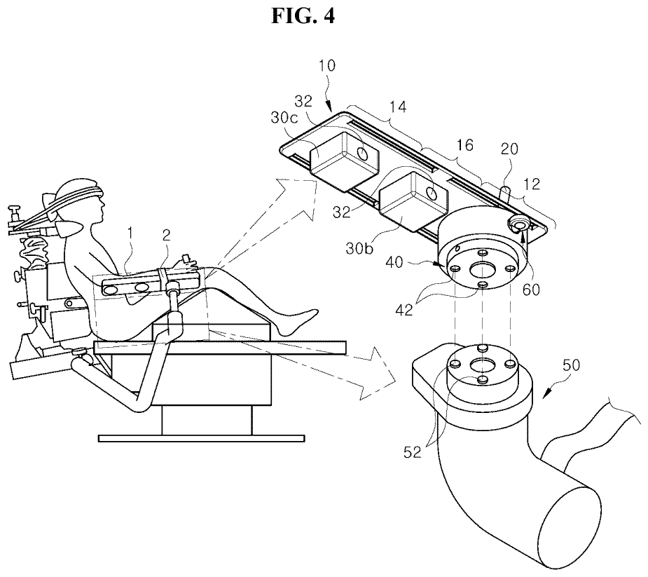

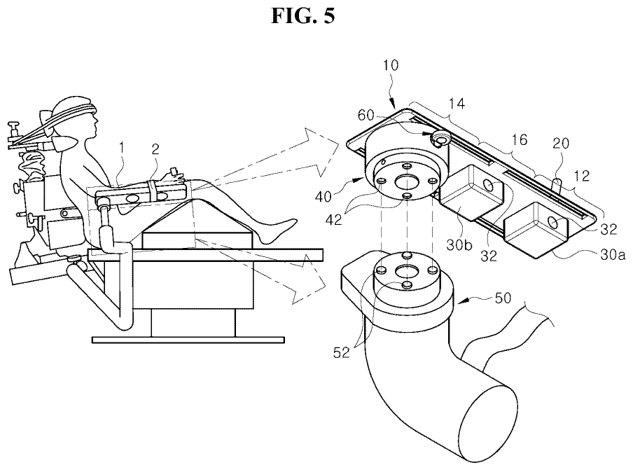

FIG. 1 is a schematic view illustrating a state, in which a central frame 30b of a medical hand and forearm fixing device is coupled to a robot arm 50 are coupled to each other, according to an embodiment of the present disclosure, FIG. 2 is an exploded perspective view illustrating the medical hand and forearm fixing device according to an embodiment of the present disclosure, FIG. 3A is a perspective view illustrating a state, in which a user's hand grips a handle 20 of the medical hand and forearm fixing device according to an embodiment of the present disclosure, FIG. 3B is a perspective view illustrating a state, in which a user's hand is separated from the handle 20 of a medical hand and forearm fixing device according to an embodiment of the present disclosure, FIG. 4 is a schematic view illustrating a state, in which a proximal frame 30a of a medical hand and forearm fixing device and the robot arm 50 are coupled to each other, according to an embodiment of the present disclosure, and FIG. 5 is a schematic view illustrating a state, in which a distal frame 30c of a medical hand and forearm fixing device and the robot arm 50 are coupled to each other, according to an embodiment of the present disclosure.

As illustrated in FIGS. 1 and 2, a medical hand and forearm fixing device according to one embodiment of the present disclosure may include a fixing part 10, a handle 20, frames 30a, 30b, and 30c, and a connector 40.

The fixing part 10 serves to fix a forearm 1 of a user. The forearm 1 of the user may be fixed to one side surface of the fixing part 10. Here, the one surface the fixing part 10, to which the forearm 1 of the user is fixed, may be an upper surface of the fixing part 10.

As an example, the fixing part 10 may firmly fix the forearm 1 of the user through a strap 2. The strap 2 may surround the fixing part 10 and the forearm 1 of the user and may serve to firmly fix the forearm 1 of the user to the strap. Furthermore, a plurality of straps 2 may be provided.

As another example, the fixing part 10 may have a rectangular shape.

In another example, the fixing part 10 may include a proximal section 12, in which a proximal portion of the forearm 1 is held, a distal section 14, in which a distal portion of the forearm 1 is held, and a central section 16, in which a portion between the proximal portion and the distal portion of the forearm 1 is held. Here, the proximal portion of the forearm 1 may be a wrist, the distal portion of the forearm 1 may be an elbow, and the portion between the proximal portion and the distal portion of the forearm 1 may be a portion between the wrist and the elbow.

As illustrated in FIGS. 3A and 3B, the handle 20 may be gripped by the hand of the user. The handle 20 may be configured to be tilted with respect to one surface of the fixing part 10, and more specifically, the handle 20 may be configured to be tilted at a specific angle al corresponding to a radial tilt of the wrist of the user with respect to a perpendicular direction that is perpendicular to the one surface of the fixing part 10. Accordingly, when the user grips the handle 20, fatigue of the wrist of the user may be reduced. Meanwhile, the specific angle a1 may be 10° to 12°.

As an example, the handle 20 may be provided in the proximal section 12 of the fixing part 10.

As another example, the handle 20 may be tilted in a direction that becomes more distant from the distal section 14 of the fixing part 10 with respect to the perpendicular direction that is perpendicular to one surface of the fixing part 10.

A plurality of frames 30a, 30b, and 30c may be provided on an opposite surface of the fixing part 10 at intervals. Any one of the plurality of frames 30a, 30b, and 30c may be selectively connected to the robot arm 50 through the connector 40, so that a fixing position of the robot arm 50 with respect to the fixing part 10 becomes various at a plurality of points, thereby providing versatility. Furthermore, the opposite surface of the fixing part 10, on which the plurality of frames 30a, 30b, and 30c are provided, may be a lower surface of the fixing part 10.

A through-hole 32 may be formed in each of the frames 30a, 30b, and 30c. The through-hole 32 may be formed to pass along a central axis line of the frames 30a, 30b, and 30c. Furthermore, the through-hole 32 may communicate with a communication hole 46 of the connector 40, which will be described later, and details thereof will be described later.

The plurality of frames 30a, 30b, and 30c may include a proximal frame 30a, a central frame 30b, and a distal frame 30c. Here, the proximal frame 30a may be provided in the proximal section 12 of the fixing part 10, the central frame 30b may be provided in the central section 16 of the fixing part 10, and the distal frame 30c may be provided in the distal section 14 of the fixing part 10. Any one of the proximal frame 30a, the central frame 30b, and the distal frame 30c may be selectively connected to the robot arm 50 through the connector 40.

The connector 40 may be coupled to any one of the plurality of frames 30a, 30b, and 30c to be separable, and may be provided in the robot arm 50.

As an example, a plurality of fixing recesses 42 may be formed in the connector 40, and a plurality of fixing projections 52 that are fixed to the plurality of fixing recesses 42, respectively, may be formed in the robot arm 50. That is, the connector 40 and the robot arm 50 may be fixed to be separable through the fixing of the plurality of fixing recesses 42 and the plurality of fixing projections 52.

As another example, an insertion recess 44, into which the frame 30a, 30b, or 30c is inserted, may be formed in the connector 40. The insertion recess 44 may have a shape corresponding to the frames 30a, 30b, or 30c and may be recessed at a center of one surface of the connector 40.

As another example, a pair of communication holes 46 that are formed to communicate with opposite sides of the insertion recess 44 may be formed in the connector 40. The communication hole 46 may be formed to pass from a circumferential surface of the connector 40 to a circumferential surface of the insertion recess 44. Furthermore, a pair of communication holes 46 may be formed in a row in the connector 40. Here, while the frames 30a, 30b, and 30c are inserted into the insertion recess 44 of the connector 40, the pair of communication holes 46 may communicate with opposite sides of the through-hole 32, respectively. While the frames 30a, 30b, and 30c are inserted into the insertion recess 44 of the connector 40, the frame 30a, 30b, or 30c and the connector 40 may be locked by a locking part 60.

While the frames 30a, 30b, and 30c are inserted into the insertion recess 44 of the connector 40, the locking part 60 may lock the frame 30a, 30b, or 30c and the connector 40. The locking part 60 may include a locking body 62, a locking guide 64, and a locking step 66.

While the frames 30a, 30b, and 30c are inserted into the insertion recess 44, the locking body 62 may be inserted into the communication holes 46 and the through-hole 32. The locking body 62 may substantially serve to lock the frames 30a, 30b, and 30c and the connector 40.

As an example, the locking body 62 may have a cylindrical shape.

The locking guide 64 may be provided at one end of the locking body 62, and may have a shape, of which a cross-sectional area decreases in a direction that becomes more distant from the locking body 62. The locking guide 64 may serve to allow the locking body 62 to be easily inserted into the communication holes 46 and the through-hole 32.

The locking step 66 may be provided at an opposite end of the locking body 62, and may be stopped by the frame 30a, 30b, or 30c when the locking body 62 is inserted into the communication holes 46 and the through-hole 32. The locking step 66 may serve to prevent the locking body 62 from being completely inserted into the communication hole 46.

As an example, a hollow hole may be formed in the locking step 66. The hollow hole may be used to allow the user to insert the finger thereinto, and to manually insert the locking body 62 into the communication holes 46 and the through-hole 32.

Meanwhile, the medical hand and forearm fixing device according to one embodiment of the present disclosure may further include a controller (not illustrated).

The controller serves to control the robot arm 50. The controller may control the robot arm 50 differently depending on a coupling portion of the connector 40 to the plurality of frames 30a, 30b, and 30c. Here, the robot arm 50 may allow at least one of a shoulder joint motion of the user and an elbow joint motion of the user to be performed while moving the fixing part 10, to which the forearm 1 of the user is fixed, under the control of the controller.

As an example, when the connector 40 is coupled to the proximal frame 30a, among the plurality of frames 30a, 30b, and 30c, the controller may control the robot arm 50 such that the shoulder joint motion of the user is performed. Specifically, the controller may control the robot arm 50 to apply a large force that is necessary to induce intensive motion in the shoulder joint of the user, which is suffering from stiffness. In this case, it may be advantageous for treating the disease, in which the user's shoulder joint motion range has been moderately or more severely reduced, to recover and maintain the range of joint motion. (see FIG. 1)

As another example, when the connector 40 is coupled to the central frame 30b, among the plurality of frames 30a, 30b, and 30c, the controller may control the robot arm 50 such that the shoulder joint motion of the user or the elbow joint motion of the user is performed. Specifically, the controller may control the shoulder joint motion of the user or the elbow joint motion of the user, and may control the robot arm 50 such that the shoulder joint motion of the user or the elbow joint motion of the user is selectively performed. (see FIG. 4)

As another example, when the connector 40 is coupled to the distal frame 30c, among the plurality of frames 30a, 30b, and 30c, the controller may control the robot arm 50 such that at least one of the shoulder joint motion of the user and the elbow joint motion of the user is performed. Specifically, the controller may control the robot arm 50 so that the shoulder joint motion of the user and the elbow joint motion of the user are performed together. Furthermore, the controller may control the robot arm 50 so that the shoulder joint motion of the user or the elbow joint motion of the user is selectively performed. In this case, when there is adhesion at upper and lower portions of the shoulder joint capsule, there is restriction of an adduction-external rotation posture, and it may be advantageous for performing an adduction-external rotation joint motion range of the shoulder joint. (see FIG. 5)

Meanwhile, when the connector 40 is coupled to the proximal frame 30a, among the plurality of frames 30a, 30b, and 30c, the robot arm 50 may have a smaller range of motion and a greater power compared to the robot arm 50 when the connector 40 is coupled to the distal frame 30c, among the plurality of frames 30a, 30b, and 30c.

Furthermore, when the connector 40 is coupled to the distal frame 30c, among the plurality of frames 30a, 30b, and 30c, the robot arm 50 may have a greater range of motion and a smaller power compared to the robot arm 50 when the connector 40 is coupled to the proximal frame 30a, among the plurality of frames 30a, 30b, and 30c.

Furthermore, when the connector 40 is coupled to the central frame 30b, among the plurality of frames 30a, 30b, and 30c, the robot arm 50 may have a smaller range of motion compared to the robot arm 50 when the connector 40 is coupled to the distal frame 30c, among the plurality of frames 30a, 30b, and 30c, and may have a smaller power compared to the robot arm 50 when the connector 40 is coupled to the proximal frame 30a, among the plurality of frames 30a, 30b, and 30c.

Hereinafter, a process of fixing the forearm 1 of the user to the medical hand and forearm fixing device according to one embodiment of the present disclosure will be described. The following process may be performed by the robot arm 50 or the controller.

First, the connector 40 is fixed to the robot arm 50. In this case, a plurality of fixing projections 52 of the robot arm 50 may be fixed to a plurality of fixing recesses 42 of the connector 40.

Next, the connector 40 is selectively coupled to any one of the plurality of frames 30a, 30b, and 30c. Here, the connector 40 and the frame 30a, 30b, or 30c may be locked by the locking part 60. That is, while the frame 30a, 30b, or 30c is inserted into the insertion recess 44 of the connector 40, the locking part 60 may be inserted into the pair of communication holes 46 of the connector 40 and the through-hole 32 of the frame 30a, 30b, or 30c to lock the frame 30a, 30b, or 30c and the connector 40.

Next, the forearm 1 of the user is fixed to the fixing part 10. In this case, the arm of the user and the fixing part 10 may be more firmly fixed by using the strap 2.

Thereafter, the controller may control the robot arm 50 such that at least one of the shoulder joint motion of the user and the elbow joint motion of the user is performed.

According to the present disclosure, a forearm 1 fixing device for an upper limb joint motion range restoration and maintenance therapy robot according to one embodiment of the present disclosure may reduce fatigue of the wrist of the user that grips the handle 20, and may provide versatility.

The medical hand and forearm fixing device according to an embodiment of the present disclosure may reduce fatigue of a wrist of the user that grips the handle and has versatility.

Effects of the present disclosure are not limited to the effects mentioned above, and other effects not mentioned will be clearly understood by those skilled in the art from the following description.

Although an embodiment of the present disclosure are described with reference to the accompanying drawings, it will be understood by those skilled in the art to which the present disclosure pertains that the present disclosure can be carried out in other detailed forms without changing the scope and spirit or the essential features of the present disclosure. Therefore, the above-described embodiments are exemplary in all aspects, and should be construed not to be restrictive.

What is claimed is:

1. A medical hand and forearm fixing device comprising:
a fixing part, to which a forearm of a user is fixed; and
a handle provided on one surface of the fixing part to be tilted, and gripped by a hand of the user,
wherein the handle is configured to be tilted at a specific angle corresponding to an anatomical structure of a hand or a wrist of the user, relative to the perpendicular direction of the one surface of the fixing part.

2. The medical hand and forearm fixing device of claim 1, wherein the handle is configured to be tilted at a specific angle corresponding to a radial tilt of the wrist of the user with respect to the perpendicular direction being perpendicular to the one surface of the fixing part.

3. The medical hand and forearm fixing device of claim 2, wherein the specific angle is 10° to 12°.

4. The medical hand and forearm fixing device of claim 1, wherein the fixing part includes a proximal section, in which a proximal portion of the forearm is held, a distal section, in which a distal portion of the forearm is held, and a central section, in which a portion between the proximal portion of the forearm and the distal portion of the forearm is held, and
wherein the handle is provided in the proximal section.

5. The medical hand and forearm fixing device of claim 4, further comprising:
a plurality of frames provided on an opposite surface of the fixing part at intervals; and
a connector coupled to any one of the plurality of frames to be separable, and provided in a robot arm,
wherein the plurality of frames include:
a proximal frame provided in the proximal section;
a central frame provided in the central section; and
a distal frame provided in the distal section.

6. The medical hand and forearm fixing device of claim 5, further comprising:
a controller configured to control the robot arm,
wherein the controller is configured to:
control the robot arm such that a shoulder joint motion of the user is performed when the connector is coupled to the proximal frame;
control the robot arm such that the shoulder joint motion of the user or an elbow joint motion of the user is performed when the connector is coupled to the central frame; and
control the robot arm such that at least one of the shoulder joint motion of the user or the elbow joint motion of the user is performed when the connector is coupled to the distal frame.

7. The medical hand and forearm fixing device of claim 1, wherein an insertion recess, into which the frame is inserted, is formed in the connector.

8. The medical hand and forearm fixing device of claim 7, wherein a through-hole is formed in the frame,
wherein a pair of communication holes for fluid-communication are formed in the connector on opposite sides of the insertion recess,
wherein the pair of communication holes communicate with opposite sides of the through-hole while the frame is inserted into the insertion recess, and
wherein the medical hand and forearm fixing device further includes a locking part inserted into the pair of communication holes and the through-hole, and configured to lock the frame and the connector while the frame is inserted into the insertion recess.

9. The medical hand and forearm fixing device of claim 8, wherein the locking part includes:
a locking body inserted into the communication holes and the through-hole while the frame is inserted into the insertion recess; and
a locking guide provided at one end of the locking body, and having a shape, a cross-sectional area of which decreases in a direction becoming more distant from the locking body.

10. The medical hand and forearm fixing device of claim 9, wherein the locking part further includes:
a locking step provided at an opposite end of the locking body, and stopped by the frame when the locking body is inserted into the pair of communication holes and the through-hole.

11. The medical hand and forearm fixing device of claim 10, wherein a hollow hole is formed in the locking step.
